(19) United States
(12) Patent Application Publication
(10) Pub. No.: US 2026/0204583 A1
(43) Pub. Date: Jul. 16, 2026

(54) LITHIUM ION BATTERY HAVING A LITHIATED NAFION ELECTRODE

(71) Applicant: GM Global Technology Operations LLC, Detroit, MI (US)

(72) Inventors: Yong Lu, Shanghai (CN); Haijing Liu, Shanghai (CN)

(21) Appl. No.: 19/055,997

(22) Filed: Feb. 18, 2025

(30) Foreign Application Priority Data
Jan. 15, 2025 (CN) 202510069275.9

(51) Int. Cl. H01M 4/62; H01M 4/02; H01M 4/131; H01M 4/36; H01M 10/0525

(52) U.S. Cl. CPC H01M 4/628; H01M 4/131; H01M 4/366; H01M 10/0525; H01M 2004/021; H01M 2004/028

(57) ABSTRACT

A rechargeable lithium ion battery is provided. The battery includes a cathode having a current collector and an electrode active layer coated onto the current collector. The electrode active layer includes a cathode active material and a Lithiated Nafion (Li-Nafion) in direct contact with the cathode active material and liquid electrolyte. The Li-Nafion is deposited directly on the external surface area of the cathode material, such that the Li-Nafion is an interface between the liquid electrolyte and the cathode material. The Li-Nafion may be deposited as a coating or a plurality of particles covering a portion of the external surface of individual cathode material particles. The cathode having Li-Nafion covered cathode material particles delivers improved discharge rate performance, cycling stability as well as the fast charge capability, which arise from high voltage stability and Li ion conduction ability.

This application is based on and claims the benefit of priority from Chinese Patent Application No. 202510069275.9, filed on 15 Jan. 2025, the entirety of which is incorporated by reference herein.

The present disclosure relates to rechargeable batteries, particularly to a lithium ion battery having a Lithiated Nafion (Li-Nafion) electrode, more specifically a positive electrode having a Li-Nafion covered cathode active material.

Rechargeable lithium ion batteries have the ability to hold a relatively high energy density, a relatively low internal resistance, and a low self-discharge rate when not in use as compared to older types of rechargeable batteries such as nickel metal hydride, nickel cadmium, or lead acid batteries. Electric and hybrid vehicles predominantly use rechargeable lithium ion batteries as a dependable power source due to the lithium ion batteries' ability to undergo repeated power cycling over their useful lifetimes.

A rechargeable lithium ion battery cell typically include a positive electrode, a negative electrode, a separator layer disposed between the positive and negative electrodes, and an electrolyte. The positive electrode is referred to as a cathode electrode and includes a cathode active material layer arranged on a cathode current collector. The negative electrode is referred to as an anode electrode and includes an anode active material layer arranged on an anode current collector.

Thus, while rechargeable lithium batteries achieve their intended purpose for use in electric and hybrid vehicles, there is a need for continuous improvement to enhance the performance and operational life of the batteries.

### SUMMARY

According to several aspects, a rechargeable lithium ion battery is provided. The battery includes a liquid electrolyte and an electrode in direct contact with the liquid electrolyte. The electrode includes a current collector and an electrode active layer coated onto the current collector. The electrode active layer includes an electrode active material and a Lithiated Nafion (Li-Nafion) in direct contact with the electrode active material and liquid electrolyte.

In an additional aspect of the present disclosure, the electrode active material is a cathode material having an external surface. The Li-Nafion is deposited directly on the external surface of the cathode material, such that the Li-Nafion is an interface between the liquid electrolyte and the cathode material.

In another aspect of the present disclosure, the cathode material includes a plurality of cathode material particles. At least one of the plurality of cathode material particles includes an external surface. The Li-Nafion is deposited directly onto the external surface of the at least one of the plurality of cathode material particles.

In another aspect of the present disclosure, the Li-Nafion is deposited as a Li-Nafion coating directly onto the external surface of the at least one of the plurality of cathode material particles and covers between 10 to 90 percent of the external surface. The Li-Nafion coating includes a thickness of between 10 nano-meter (nm) to 5 micro-meter (um).

In another aspect of the present disclosure, the Li-Nafion is deposited as a plurality of Li-Nafion particles uniformly spaced on the at least one of the plurality of cathode material particles. Individual Li-Nafion particles includes a diameter of 2 nm to 5 μm.

In another aspect of the present disclosure, the Li-Nafion particles cover 2% to 20% of the external surface of the at least one of the plurality cathode material particles.

In another aspect of the present disclosure, the plurality of cathode material particles includes single-crystals having a median particle diameter (D50) between 2 to 6 μm.

In another aspect of the present disclosure, the electrode active layer further includes 77 weight percent (wt %) to 98.9 wt % of a cathode material; 0.1 wt % to 10 wt % of the Li-Nafion; 0.5 wt % to 5 wt % of a conductive material; and 0.5 to 8 wt % of a binder.

According to several aspects, an electrode for a battery is provided. The electrode includes 77 weight percent (wt %) to 98.9 wt % of a lithium based active material; 0.1 wt % to 10 wt % of the Li-Nafion; 0.5 wt % to 5 wt % of a conductive material; and 0.5 to 8 wt % of a binder.

In an additional aspect of the present disclosure, the active material includes a plurality of cathode material particles. Individual cathode material particles includes an external surface. The Li-Nafion is deposited directly onto the external surface of the individual cathode material particles.

In another aspect of the present disclosure, the Li-Nafion is deposited as a coating covering about 60 percent of the external surfaces of the individual cathode material particles and includes a thickness of between 50 nano-meter (nm) to 2 micro-meter (um).

In another aspect of the present disclosure, the Li-Nafion is deposited as a plurality of Li-Nafion particles onto 2% to 30% the external surface of the individual cathode material particles and includes a diameter of 2 nm to 5 μm.

In another aspect of the present disclosure, the Li-Nafion includes a molecular weight of between about 10,000 to 1,500,000.

According to several aspects, an electrode for a rechargeable lithium ion battery is provided. The electrode includes 77 weight percent (wt %) to 98.9 wt % of a lithium based active material; 0.1 wt % to 10 wt % of Li-Nafion; 0.5 wt % to 5 wt % of a conductive material; and 0.5 to 8 wt % of a binder.

In an additional aspect of the present disclosure, the lithium based active material includes at least one of LiNiₓCo_{y}Mn_{1-x-y}O₂ (NCM), LiNiₓCo_{y}Mn_{1-x-y-z}Al_{z}O₂ (NCMA), LiNiₓCo_{y}Mn_{1-x-y}O₂ (NCA), LiNiₓMn_{1-y}Al_{1-x-y}O₂ (NMA), LiNiₓMn₁₋ₓO₂ (NM), Lithium-manganese rich (LMR) materials, LiNi_{0.5}Mn_{1.5}O₂ (LNMO), LiMn₂O₄ (LMO), LiFePO₄ (LFP), LiFeₓMn₁₋ₓPO₄ (LFMP, 0.1≤x≤0.5), and LiCoO₂ (LCO).

In another aspect of the present disclosure, the lithium based active material comprises a plurality of active material particles. The Li-Nafion is deposited directly onto 10 to 90% of the external surface of the at least one of the plurality of active material particles forming a coating having a thickness of between 10 nano-meter (nm) to 5 micro-meter (um).

In another aspect of the present disclosure, the lithium based active material includes a plurality of active material particles. The Li-Nafion is deposited as a plurality of Li-Nafion particles uniformly spaced on 2% to 20% the external surface of the at least one of the plurality of cathode material particles.

In another aspect of the present disclosure, an individual Li-Nafion particles includes a diameter of 2 nm to 5 μm.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic representation of a cross-section of a rechargeable lithium ion battery, according to an exemplary embodiment;

FIG. 2 is a diagrammatic representation of a detailed portion of a positive electrode having Li-Nafion coated active material, according to an exemplary embodiment;

FIG. 3A is a diagrammatic representation of a cross-section of a Li-Nafion coated active material, according to an exemplary embodiment;

FIG. 3B is a diagrammatic representation of a cross-section of a Li-Nafion coated active material, according to another exemplary embodiment;

FIG. 4 is a block diagram of a method of making an electrode having a Li-Nafion coated active material, according to another exemplary embodiment; and

FIGS. 5A-5C are graphs showing the improved performance of a positive electrode having a Li-Nafion coated active material, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Numerical data is presented herein in a range format. “The term “about” as used herein is known by those skilled in the art. Alternatively, the term “about” includes +/−0.5%” of the stated value. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

A rechargeable lithium ion battery cell typically include a positive electrode, a negative electrode, a separator layer disposed between the positive and negative electrodes, and a liquid electrolyte. Rechargeable lithium ion battery cells capable of elevated charge cutoff limits of greater than 4.3 volts provides an effective way to enhance the energy density. However, at charge voltages higher than the traditional limit of 4.2 volts, the positive electrode may experience degradation of the cathode active materials resulting from chemical reactions at the interface between the cathode active materials and the liquid electrolyte. The following provides a novel solution of covering the cathode active materials with Lithiated Nafion to reduce degradation of the cathode active materials thus improving discharge rate performance, cycling stability, as well as fast charging capability.

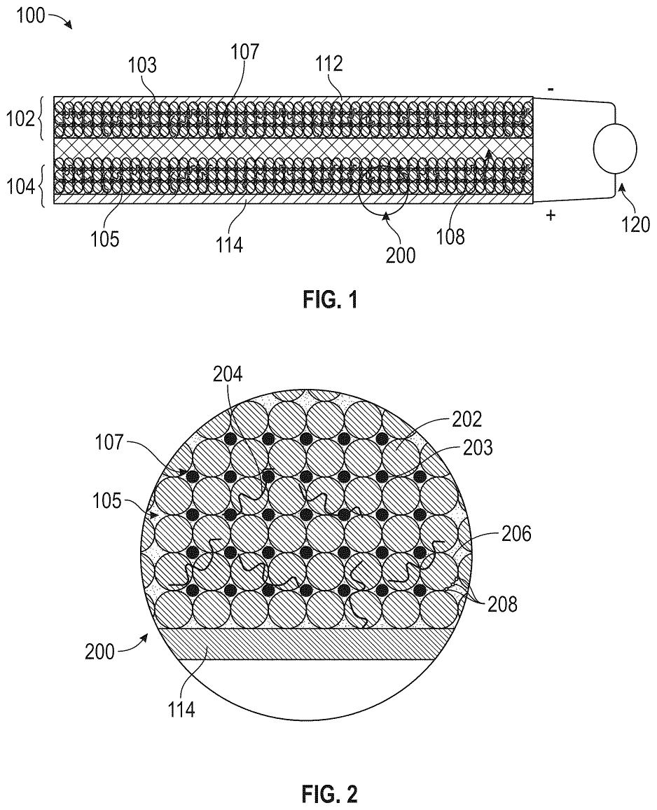

FIG. 1 is a diagrammatic representation of a rechargeable lithium-ion battery cell, generally indicated by reference number 100. A single lithium-ion battery cell is also referred to as a battery 100. The battery 100 is capable of a voltage charge of at least 4.3 volts (V) using Li/Li+ as an electrode reference. The battery 100 includes a negative electrode 102, a positive electrode 104, and a separator layer 108 disposed between the negative electrode 102 and positive electrode 104. The separator layer 108 includes a material suitable for enabling lithium ions exchange between the negative electrode 102 and the positive electrode 104. The battery 100 further includes a liquid electrolyte 107 permeating through the negative electrode 102, positive electrode 104, and separator layer 108. The liquid electrolyte 107 is suitable for conducting lithium ions between the negative electrode 102 and the positive electrode 104 through the separator layer 108. Non-limiting examples of liquid electrolyte 107 includes, but are not limited to, carbonates-based electrolytes such as 1 M LiPF₆ in EC/EMC (3/7, v/v)+2 wt % FEC+1 wt % VC. Solid-electrolytes and gel electrolytes may also be included to enhance the performance of the battery 100.

The negative electrode 102 includes a lithium accepting active material layer 103 and the positive electrode 104 includes a lithium-based active material layer 105 that can store lithium ions at a higher electric potential than the lithium accepting active material layer 103, or host material 103, of the negative electrode 102. The positive electrode 104 is also referred to as a cathode 104 due to its higher electrochemical potential and the negative electrode 102 is also referred to as an anode 102 due to its relatively lower electrochemical potential. Each of the lithium accepting active material layer 103 of the anode 102 and lithium-based active material layer 105 of the cathode 104 is coated onto a respective current collector 112, 114. The current collectors 112, 114 may be formed from electrically conductive metals such as copper for the negative electrode 102 and aluminum for the positive electrode 104.

In a non-limiting example, the lithium accepting active material layer 103 of the anode 102 includes market available anode materials such as graphite, hard carbon, LSO, Si, SiOx, etc. The morphology of the Si-based materials may include nano particles, nano fibers, nano tubes and micro particles etc.

FIG. 2 shows a diagrammatic representation of a detailed section 200 of FIG. 1. The detailed section 200 shows a portion of the cross-section of the positive electrode 104. The positive electrode 104 includes a cathode active material layer 105 coated onto the current collector 114. The cathode active material layer 105 includes a plurality of cathode material particles 202, a plurality of conductive materials 203, and a binder 204. Individual cathode material particles 202 includes an external surface area 206 having a Lithiated Nafion (Li-Nafion) deposit in a form of a coating and/or decorative particles. The spaces between the individual cathode material particles 202, conductive materials 203, and binder 204 are permeated with a liquid electrolyte 107 such that the Li-Nafion coating 208 is in direct contact with the liquid electrolyte 107. In a non-limiting example, the cathode active layer 105 includes about 77.0 to 98.9 weight percent (wt %) of cathode active material particles 202; 0.1 to 10.0 wt % of Li-Nafion; 0.5 to 5.0 wt % of conductive material; and 0.5 to 8.0 wt % of binder.

The Li-Nafion is represented by the chemical structure:

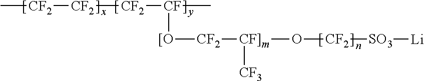

Wherein when m>0 then n≥0; when m=0 then n≥1, and x≥1 and y≥1. For example, m≥1,n=2, y=100, x=5~13.5. The molecular weight of Li-Nafion is between about 10,000 to 1,500,000, preferably 100,000 to 1,000,000.

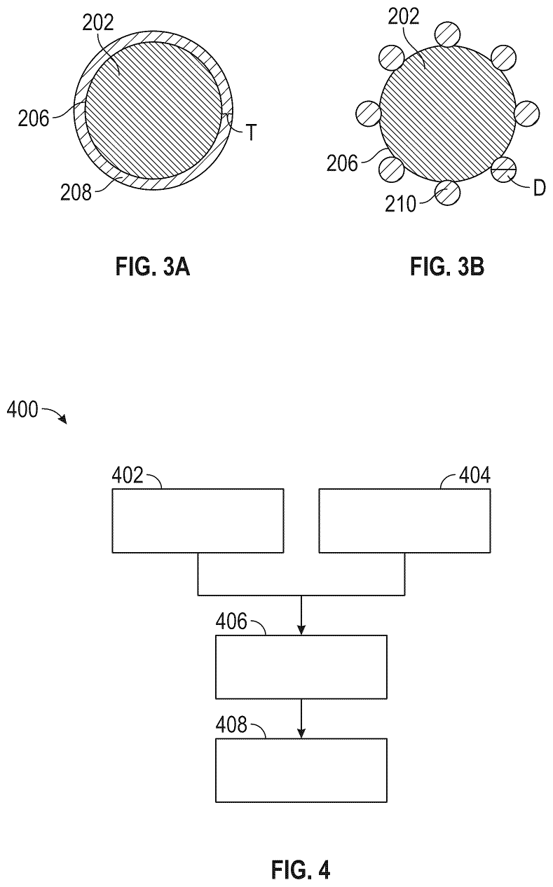

FIG. 3A shows a diagrammatic representation of a cross-section of an embodiment of an individual Li-Nafion coated cathode material particle 202. Approximately greater than 5% to less than 100%, preferably 10% to less than 90%, of the external surface area 206 is covered with a Li-Nafion coating 208. More preferably, 60% of the external surface area 206 is covered with a Li-Nafion coating 208. The Li-Nafion coating 208 includes a thickness (T) of between about 10 nano-meter (nm) to 5 micro-meter (um), preferably 50 nm to 2 μm.

FIG. 3B shows a diagrammatic representation of a cross-section of another embodiment of a Li-Nafion coated cathode material particle 202. The Li-Nation coating 208 is in the form of a plurality of Li-Nafion particulates 210 deposited onto the external surface area 206 of the cathode active material particles 202 such that the Li-Nafion particles 210 resembles decorative particles 210. Individual Li-Nafion particulates 210 includes a diameter (D) of 2 nm to 5 μm deposited on 2% to 30% of the external surface area 206. In a non-limiting embodiment, the Individual Li-Nafion particulates 210 are deposited on the external surface area 206 such that individual Li-Nafion particulates 210 are uniformly spaced on the external surface area 206. Uniformly spaced means having a roughly equal spacing of individual Li-Nafion particulates 210 on the external surface area 206 of the cathode active material 202.

The cathode active material 202 includes, but are not limited to, LiNiₓCo_{y}Mn_{1-x-y}O₂ (NCM), LiNiₓCo_{y}Mn_{1-x-y-z}Al_{z}O₂ (NCMA), LiNiₓCo_{y}Mn_{1-x-y}O₂ (NCA), LiNiₓMn_{1-y}Al_{1-x-y}O₂ (NMA), LiNiₓMn₁₋ₓO₂ (NM), Lithium-manganese rich (LMR) materials, LiNi_{0.5}Mn_{1.5}O₂ (LNMO), LiMn₂O₄ (LMO), LiFePO₄ (LFP), LiFeₓMn₁₋ₓPO₄ (LFMP, 0.1≤x≤0.5), LiCoO₂ (LCO), preferably high-voltage NCM, NM (N>70%), LMR, LNMO, LCO. The cathode materials 202 includes single-crystals having a median particle diameter (D50) between 2 to 6 μm. A single crystal structure contributes to steady charge/discharge cycling without breaking down into smaller particles.

The conductive additive includes at least one of carbon black, graphite, graphene, graphene oxide, Super P, acetylene black, carbon nanofibers, carbon nanotubes and other electronically conductive additives.

The cathode binder material includes at least one of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS) and so on.

FIG. 4 is a block diagram of a method of making an electrode, preferably the cathode, having a Li-Nafion covered active material (Method 400). The Method 400 starts in Block 402 and Block 404. At Block 402, the binder is mixed with N-Methyl-pyrrolidone (NMP) to form a Binder/NMP slurry. At Block 404, a Li-Nafion dispersion is combined with a LiOH/H₂O solution, titrated to a neutral state, and dry to form a solid Li-Nafion compound. From Block 402 and 404, preceding to Block 406. At Block 406, the Binder/NMP slurry and solid Li-Nafion compound are mixed with cathode active material powders and conductive carbons to form an electrode slurry. Proceeding to Block 408, the electrode slurry is coated onto a current collector and dried to form the cathode active layer having a Li-Nafion covered cathode active material.

A rechargeable lithium ion battery having elevated charge cutoff limits of greater than 4.3 volts is an effective way to enhance the energy density of battery cells. Such elevated voltage rechargeable lithium ion batteries having a cathode with Li-Nafion covered cathode material particles delivers improved discharge rate performance, cycling stability as well as the fast charge capability, which arise from high voltage stability and Li ion conduction ability.

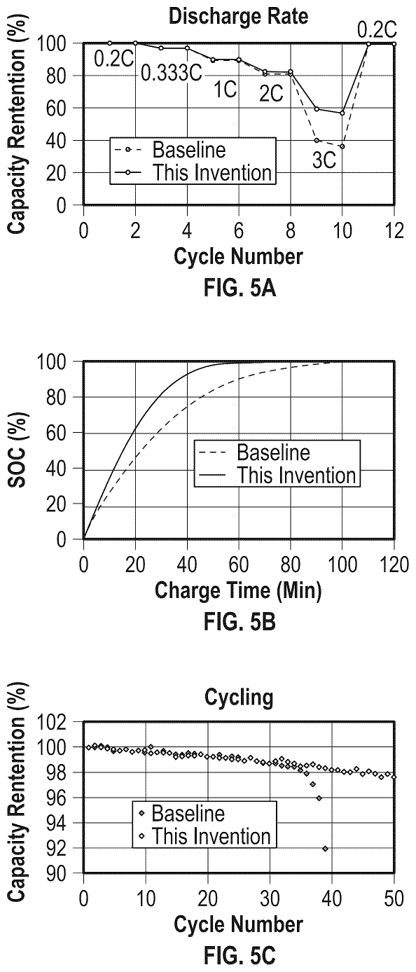

FIGS. 5A-5C shows the comparison of the discharge rate performance, fast charge performance, and cycling stability, respectively, of half coin test cells having single-crystal high voltage mid-nickel cathode active materials (LiNi_{0.6}Co_{0.1}Mn_{0.3}O₂). A traditional electrode having NCM613/SP+SCNT/PVDF in a respective weight percentages of 95/(2.9+0.1)/2 was compared with the improved electrode having NCM613/Li-Nafion/(SP+SCNT)/PVDF having a respective weight percentages of 93.67/1.4/(2.86+0.1)/1.97.

Referring to FIG. 5A, the half coin test cells having the Li-Nafion achieved improved capacity retention under 3 C discharge, about 20% improvements (charge rates fixed at 0.2 C). In FIG. 5B, from 0~80 state of charge (SOC) 2 C fast charge curves, the improved test cells contribute to approximately 16.4 minute shorter charge times (29.56 minutes vs. 45.91 minutes), indicating excellent fast charge capability. Referring to FIG. 5C, the reference traditional test cells experienced sudden capacity drops after around 35 charge-discharge cycles at C/3 while the improved test cells delivered enhanced cycling stability until 50 cycles, indicating strengthened cathode material and liquid electrolyte interfaces.

The description of the present disclosure is merely exemplary in nature. While examples have been described in detail, those familiar with the art to which this disclosure relates will recognize various alternative designs and examples for practicing the disclosed method within the scope of the appended claims. Such variations are not to be regarded as a departure from the spirit and scope of the present disclosure.

What is claimed is:

1. A battery, comprising:
a liquid electrolyte;
an electrode in contact with the liquid electrolyte, wherein the electrode comprises:
a current collector; and
an electrode active layer coated onto the current collector;
wherein in the electrode active layer comprise:
an electrode active material, and
a Lithiated Nafion (Li-Nafion) in direct contact with the electrode active material and liquid electrolyte.

2. The battery of claim 1, wherein the electrode active material is a cathode material.

3. The battery of claim 2, wherein the cathode material includes an external surface area; and the Li-Nafion is deposited directly on the external surface area of the cathode material such that the Li-Nafion is an interface between the cathode material and liquid electrolyte.

4. The battery of claim 2, wherein the cathode material comprises a plurality of cathode material particles, wherein at least one of the plurality of cathode material particles includes an external surface area; and
wherein the Li-Nafion is deposited directly onto the external surface area of the at least one of the plurality of cathode material particles.

5. The battery of claim 4, wherein the Li-Nafion is deposited as a Li-Nafion coating directly onto the external surface area of the at least one of the plurality of cathode material particles; and
wherein the Li-Nafion coating covers between 10 to 90 percent of the external surface area of the at least one of the plurality of cathode material particles.

6. The battery of claim 5, wherein the Li-Nafion coating includes a thickness of between 10 nano-meter (nm) to 5 micro-meter (um).

7. The battery of claim 4, wherein the Li-Nafion is deposited as a plurality of Li-Nafion particles uniformly spaced on the at least one of the plurality of cathode material particles; and
wherein individual Li-Nafion particles includes a diameter of 2 nm to 5 um.

8. The battery of claim 7, wherein the plurality of Li-Nafion particles cover 2% to 20% of the external surface area of the at least one of the plurality cathode material particles.

9. The battery of claim 4, wherein the plurality of cathode material particles include single-crystals having a median particle diameter (D50) between 2 to 6 um.

10. The battery of claim 1, wherein the electrode active layer further comprises:
77 weight percent (wt %) to 98.9 wt % of a cathode material;
0.1 wt % to 10 wt % of the Li-Nafion covering a portion of the cathode material;
0.5 wt % to 5 wt % of a conductive material; and
0.5 to 8 wt % of a binder.

11. An electrode for a battery, comprising:
77 weight percent (wt %) to 98.9 wt % of a lithium based active material;
0.1 wt % to 10 wt % of the Li-Nafion;
0.5 wt % to 5 wt % of a conductive material; and
0.5 to 8 wt % of a binder.

12. The electrode of claim 11, wherein:
the active material comprises a plurality of cathode material particles, wherein individual cathode material particles includes an external surface area; and
wherein the Li-Nafion is deposited directly onto the external surface area of the individual cathode material particles.

13. The electrode of claim 12, wherein the Li-Nafion is deposited as a Li-Nafion coating covering about 60 percent of the external surface area of the individual cathode material particles; and
the Li-Nafion coating includes a thickness of between 50 nano-meter (nm) to 2 micro-meter (um).

14. The electrode of claim 12, wherein the Li-Nafion is deposited as a plurality of Li-Nafion particles onto 2% to 30% the external surface area of the individual cathode material particles; and
individual Li-Nafion particles includes a diameter of 2 nm to 5 μm.

15. The electrode of claim 11, wherein the Li-Nafion includes a molecular weight of between about 10,000 to 1,500,000.

16. A rechargeable lithium ion battery, comprising:
an electrode comprising:
77 weight percent (wt %) to 98.9 wt % of a lithium based active material; and
0.1 wt % to 10 wt % of Li-Nafion;
0.5 wt % to 5 wt % of a conductive material; and
0.5 to 8 wt % of a binder; and
wherein the rechargeable lithium ion battery is capable of a voltage charge of greater than 4.3 volts.

17. The rechargeable lithium ion battery of claim 16, wherein the lithium based active material comprises at least one of LiNiₓCo_{y}Mn_{1-x-y}O₂ (NCM), LiNiₓCo_{y}Mn_{1-x-y-z}Al_{z}O₂ (NCMA), LiNiₓCo_{y}Mn_{1-x-y}O₂ (NCA), LiNiₓMn_{1-y}Al_{1-x-y}O₂ (NMA), LiNiₓMn₁₋ₓO₂ (NM), Lithium-manganese rich (LMR) materials, LiNi_{0.5}Mn_{1.5}O₂ (LNMO), LiMn₂O₄ (LMO), LiFePO₄ (LFP), LiFeₓMn₁₋ₓPO₄ (LFMP, 0.1≤x≤0.5), and LiCoO₂ (LCO).

18. The rechargeable lithium ion battery of claim 16, wherein the lithium based active material comprises a plurality of active material particles, wherein at least one of the plurality of active material particles includes an external surface area; and
wherein the Li-Nafion is deposited directly onto 10% to 90% of the external surface area of the at least one of the plurality of active material particles forming a Li-Nafion coating having a thickness of between 10 nano-meter (nm) to 5 micro-meter (um).

19. The rechargeable lithium ion battery of claim 16, wherein the lithium based active material comprises a plurality of active material particles;
wherein at least one of the plurality of active material particles includes an external surface area; and
wherein the Li-Nafion is deposited as a plurality of Li-Nafion particles uniformly spaced on 2% to 20% the external surface area of at least one of the plurality of active material particles.

20. The rechargeable lithium ion battery of claim 19, wherein an individual Li-Nafion particles includes a diameter of 2 nm to 5 μm.
